(19) United States
(12) Patent Application Publication
(10) Pub. No.: US 2025/0274437 A1
(43) Pub. Date: Aug. 28, 2025

(54) METHODS AND SYSTEMS FOR OPERATING A PROXY SERVER

(71) Applicant: Emeigh Holdings, LLC, Lincoln, NE (US)

(72) Inventors: Neil Emeigh, Bellwood, NE (US); Maksym Gutchenko, Wroclaw (PL)

(21) Appl. No.: 18/584,694

(22) Filed: Feb. 22, 2024

(51) Int. Cl. H04L 9/40

(52) U.S. Cl. CPC H04L 63/0281; H04L 63/0236; H04L 63/029

(57) ABSTRACT

Embodiments of a method, a non-transitory computer readable medium, and a proxy server are disclosed. In an embodiment, a method for operating a proxy server involves receiving at least one communication between a client and a web server, wherein the proxy server facilitates a secure tunnel between the client and the web server, determining from the at least one communication that access to the web server has been restricted, and implementing a remedial action in response to the restricted access determination.

### BACKGROUND

Content is often hosted on web servers so that the content can be easily accessed by desired consumers of the content, such as an individual trying to purchase goods or services over the Internet. However, entities that host such content might not want the content to be regularly accessed by, for example, competitors and/or web scrapers.

In order to control access to content hosted on web servers, some web servers are configured to block access from certain entities by, for example, banning access to the web servers from certain Internet Protocol (IP) addresses that are on a banned list and/or banning IP addresses based on certain observed behavior, such as too frequently accessing a web server from the same IP address. IP proxy services are available that can be used to circumvent IP-based bans by web servers. Although IP proxy services strive to avoid IP-based bans, web servers continue to ban IP addresses, including IP addresses supplied by IP proxy services, from accessing their hosted content, which can negatively impact the performance of an IP proxy service.

### SUMMARY

Embodiments of a method, a non-transitory computer readable medium, and a proxy server are disclosed. In an embodiment, a method for operating a proxy server involves receiving at least one communication between a client and a web server, wherein the proxy server facilitates a secure tunnel between the client and the web server, determining from the at least one communication that access to the web server has been restricted, and implementing a remedial action in response to the restricted access determination.

In an example of the method, determining from the at least one communication that access to the web server has been restricted involves identifying a size of the at least one communication and determining that access to the web server has been restricted in response to the size of the at least one communication.

In an example of the method, the at least one communication is an encrypted communication, and determining from the at least one communication that access to the web server has been restricted involves identifying a size of the encrypted communication and determining that access to the web server has been restricted in response to the size of the encrypted communication.

In an example of the method, the at least one communication is an encrypted communication, and determining from the at least one communication that access to the web server has been restricted involves identifying that a size of the encrypted communication is smaller than an expected size and determining that access to the web server has been restricted in response to identifying that a size of the encrypted communication is smaller than an expected size.

In an example of the method, determining from the at least one communication that access to the web server has been restricted involves identifying a domain name from the at least one communication and determining that access to the web server has been restricted in response to the identified domain name.

In an example of the method, determining from the at least one communication that access to the web server has been restricted involves identifying a pattern of domain names from multiple communications and determining that access to the web server has been restricted in response to the identified pattern of domain names.

In an example of the method, determining from the at least one communication that access to the web server has been restricted involves generating a feature vector from the at least one communication and applying the feature vector to a trained model.

In an example of the method, a proxy IP address is used as the source IP address over a portion of the at least one communication that is between the proxy server and the web server for a request from the client, and the proxy IP address is used as the destination IP address over a portion of the communication that is between the proxy server and the web server for a response from the web server.

In an example of the method, the proxy IP address is provided by the IP proxy server.

In an example of the method, the remedial action involves changing a proxy IP address that is used for the client.

In an example of the method, determining from the at least one communication that access to the web server has been restricted involves determining from the at least one communication that access to the web server has been blocked.

In an example of the method, determining from the at least one communication that access to the web server has been restricted involves determining from the at least one communication that a proxy IP address has been banned by web server.

In an example of the method, determining from the at least one communication that access to the web server has been restricted involves determining from the at least one communication that the client has been redirected.

In an example, the method further includes receiving training data at a training engine, wherein the training data is obtained from a proxy server that implements the proxy service for the client.

A non-transitory computer readable medium comprising instructions to be executed in a computer system, wherein the instructions when executed in the computer system perform a method of operating a proxy server is also disclosed. The method involves determining from at least one communication received at the proxy server that access to a web server has been restricted, wherein the at least one communication is a communication between a client and a web server and the proxy server facilitates a secure tunnel between the client and the web server, and implementing a remedial action in response to the restricted access determination.

A proxy server is also disclosed. The proxy server includes a communications interface, at least one processor, and a non-transitory computer readable medium comprising instructions to be executed by the at least one processor, wherein the instructions when executed by the at least one processor perform a method of operating the proxy server. The method involves determining from at least one communication received at the communications interface that access to a web server has been restricted, wherein the at least one communication is a communication between a client and a web server and the proxy server facilitates a secure tunnel between the client and the web server, and implementing a remedial action in response to the restricted access determination.

Another method for operating a proxy server is disclosed. The method involves receiving an encrypted communication at the proxy server, the encrypted communication being part of an encrypted communication between a client and a web server that passes through the proxy server, the client having a client IP address and wherein a portion of the encrypted communication that is between the proxy server and the web server uses a proxy IP address instead of the client IP address, determining from the encrypted communication that access to the web server has been restricted for the proxy IP address, and implementing a remedial action in response to the restricted access determination.

Another method for operating a proxy server is disclosed. The method involves receiving at least one communication between a client and a web server, wherein the proxy server facilitates a secure tunnel between the client and the web server, determining from the at least one communication that access to the web server may be restricted, and implementing a remedial action in response to the restricted access determination.

In an example of the method, determining from the at least one communication that access to the web server may be restricted involves identifying a domain name from the at least one communication and determining that access to the web server has been restricted in response to the identified domain name.

In an example of the method, determining from the at least one communication that access to the web server may be restricted involves identifying a pattern of domain names from multiple communications and determining that access to the web server has been restricted in response to the identified pattern of domain names.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 illustrates an example operation of an IP proxy service in a network that includes a client, an IP proxy server, and a web server.

FIG. 2 illustrates a timeline of communications between a client, a proxy server, and a web server to implement a secure connection between the client and the web server.

FIG. 3A illustrates communications between clients and a web server that pass through a proxy server.

FIG. 3B depicts an example of a packet that is used to communicate between the lower client and the web server using HTTPS.

FIG. 4 illustrates an example operation of an IP proxy service in a network in which the IP proxy server can determine from an encrypted communication that access to the web server has been restricted for a particular proxy IP address.

FIG. 5 is a timeline of encrypted communications between a client and a web server that pass through a proxy server.

FIG. 6 is another timeline of encrypted communications between a client and a web server that pass through an IP proxy server.

FIG. 7 is another timeline of operations between a client, an IP proxy server, and a web server.

FIG. 8 illustrates an example training operation for an IP proxy service in a network in which an IP proxy server provides proxy IP addresses to clients for accessing web servers.

FIG. 9 is an example of training data that may be accumulated by the ML training engine.

FIG. 10 depicts a functional block diagram of an example of a band detection engine.

FIG. 11 illustrates an example of a training operation that is implemented at the training engine.

FIG. 12 illustrates an example of an inference operation that is implemented at the inference engine.

FIG. 13 is a process flow diagram of operations performed at a proxy server.

FIG. 14 depicts an example of a computer that can implement the operations of a proxy server as described herein.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

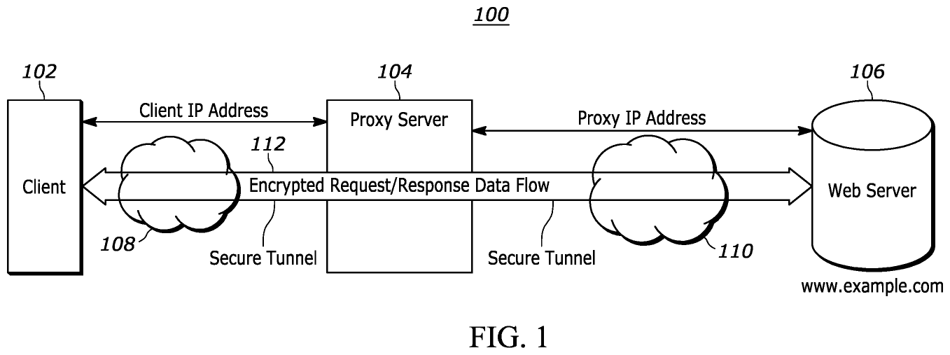

FIG. 1 illustrates an example operation of an IP proxy service in a network 100 that includes a client 102, a proxy server 104, and a web server 106, where the client, proxy server, and web server are connected via networks 108 and 110, such as WANs that use the Internet Protocol (IP) to communicate. More specifically, FIG. 1 illustrates an example operation of an IP proxy service in the case where communications (e.g., secure tunnel 112) between the client and the web server are encrypted, for example, using Hypertext Transfer Protocol Secure (HTTPS). As illustrated in FIG. 1, the encrypted communications between the client and the web server (e.g., both HTTPS requests and HTTPS responses) may be referred to as a secure tunnel, for example, a Secure Socket Layer (SSL)/Transport Layer Security (TLS) tunnel. In the example of FIG. 1, the proxy server is not able to decrypt any of the encrypted information carried in the HTTPS requests or in the HTTPS responses.

With regard to FIG. 1, the client 102 includes a computing device that is configured to interact with web servers using, for example, HTTP and HTTPS. In an example, the client has a software stack that includes an operating system such as WINDOW, MACOS, LINUX, or mobile operating systems like IOS or ANDROID. Additionally, the client may host a web browser application, such as GOOGLE CHROME or MICROSOFT EDGE, that is capable of implementing HTTP/HTTPS, initiating HTTP requests to access and retrieve content from web servers, and capable of reading HTTP responses. The HTTP requests and HTTP responses enable the client to send and receive data, including web pages, images, videos, and other resources, facilitating interaction and content retrieval from the web server over the Internet. In an example, the web browser of the client may access web servers using a secure protocol, e.g., via port 443 of a transport layer protocol such as TCP or UDP. In an example, a computer device of the client may include a computing system, such as a desktop computer, laptop computer, tablet, and/or smartphone, which includes at least one processor and memory to execute computer readable instructions. In an embodiment, the computing devices include a processor, memory, at least one user interface, and a communications interface (wired or wireless) that can communicate with a network, such as a LAN and/or WAN. In an embodiment, the client device runs an operating system, such as the WINDOWS operating system from MICROSOFT, although other operating systems are possible.

The web server 106 described herein may include a computing system configured to host and deliver web content over the Internet. In an example, the web server includes hardware and software components, such as, a central processing unit (CPU), memory modules, storage drives, network interface cards, and a power supply unit housed within a server-grade chassis. In an example, a software stack run by the web server incorporates an operating system, such as LINUX or WINDOWS Server, along with web server software like Apache HTTP Server, NGINX, or MICROSOFT Internet Information Services (IIS). In an example, the web server is configured to communicate using HTTP for unencrypted communications and HTTPS for encrypted communications. The HTTP/HTTPS protocols allow the server to respond to client requests by serving web pages, files, or other resources stored on the server, ensuring reliable and secure data transmission over the Internet. In an example, the web server may be implemented on a single server computer, or the web server may include multiple computing devices that are operatively connected to each other by, for example, a LAN and/or a WAN, which operating together provide web server functionality to clients. Thus, the web server may be distributed amongst multiple different computing devices.

The proxy server 104 is configured to provide a proxy service, including an IP proxy service, to the client 102. As illustrated in FIG. 1 and as is known in the field of IP proxy services, the client IP address is used for communications between the client and the proxy server and a proxy IP address, which is supplied by the proxy server, is used for communications between the proxy server and the web server 106. For example, the proxy server uses a proxy IP address as the source IP address for communications passed from the client to the web server and uses the client IP address as the destination IP address for communications passed from the web server to the client. In an example, the proxy server operates as a forward proxy.

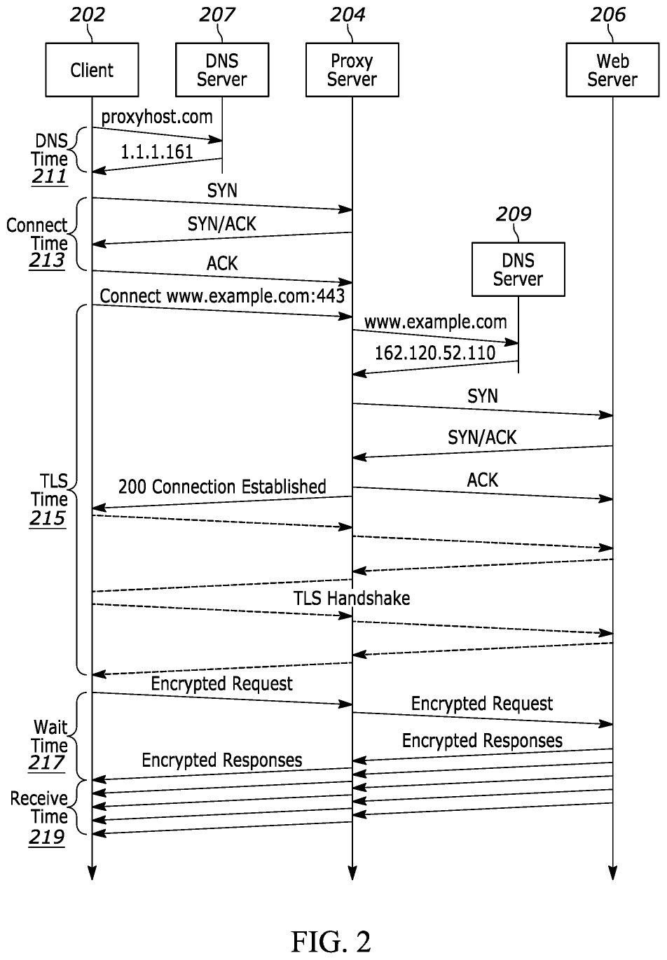

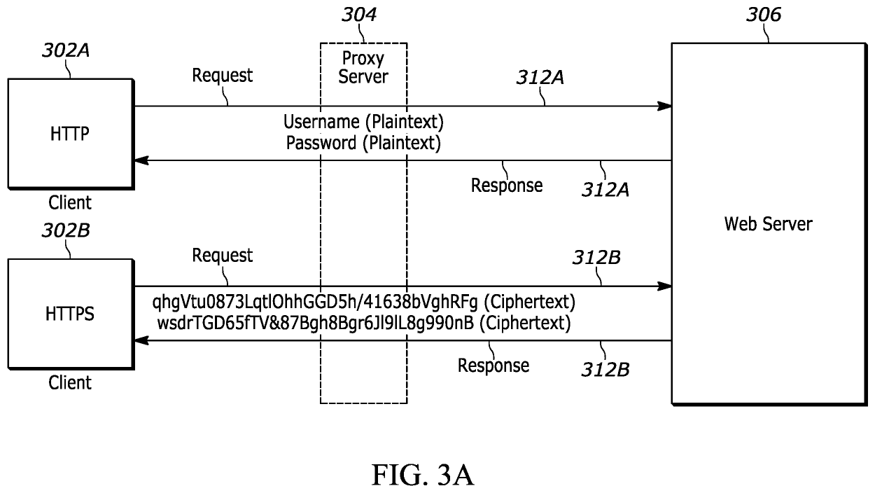

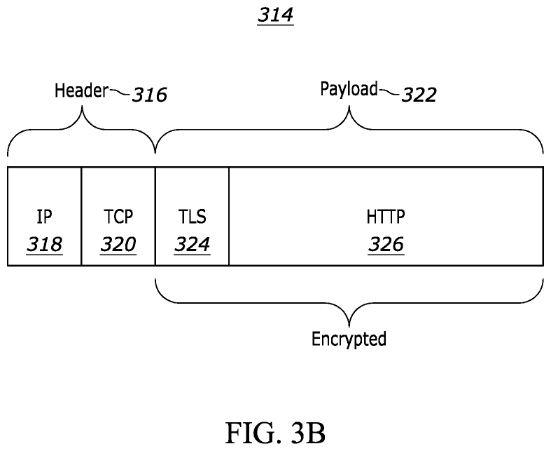

As described above, FIG. 1 illustrates operation of a secure tunnel between the client and the web server. As is known in the field, establishment of a secure tunnel between the client and the web server via a proxy server may involve various communications between the client, the proxy server, the web server, and DNS servers. FIG. 2 illustrates an example timeline of communications between a client 202, a proxy server 204, and a web server 206 that correspond to the secure tunnel 112 illustrated in FIG. 1. In the example of FIG. 2, there are communications between the client, the proxy server, the web server, and two DNS servers 207 and 209. From the perspective of the client, the timeline of the communications involves a DNS time 211, a connect time 213, a TLS time 215, a wait time 217, and a receive time 219. In a first set of communications corresponding to the DNS time 211, the client communicates with the DNS server 207 to obtain an IP address of a proxy server. For example, the client sends a message (e.g., a DNS request/query) to the DNS server requesting an IP address of a proxy server (e.g., proxyhost.com) and the DNS server returns the IP address (e.g., 1.1.1.161) of the proxy server. In other embodiments, the client may already know the IP address of the proxy host and may forgo a DNS request. In a next set of communications corresponding to the connect time 213, the client establishes a connection (e.g., a TCP connection) with the proxy server that corresponds to the IP address. For example, the client sends a SYN message, the proxy server returns a SYN-ACK message, and the client returns an ACK message. In a next set of communications corresponding to the TLS time 215, the client, proxy server, and web server interact to establish a secure tunnel between the client and the server. First, the client sends a CONNECT request to the proxy server to connect to the domain name of, for example, “example.com” using port 443 (e.g., TCP port 443). Next, the proxy server sends a message to the DNS server 209 (which may be the same DNS server or a different DNS server) requesting an IP address of the domain name “example.com” and the DNS server returns the IP address (e.g., 162.120.52.110) of the domain name example.com. In other embodiments, the proxy server may already know the IP address of the requested domain name. In a next operation, the proxy server establishes a connection (e.g., a TCP connection) with the web server that corresponds to the IP address (e.g., 162.120.52.110). For example, the proxy server sends a SYN message, the web server returns a SYN-ACK message, and the proxy server returns an ACK message. Once a connection between the proxy server and the web server is established (e.g., a TCP connection), the proxy server sends a message to the client indicating that a connection has been established (e.g., an HTTP response status code of “200 connection established”). Next, the client and the web server implement a TLS handshake. TLS handshakes are well known in the field and typically involve the client and server authenticating each other, agreeing on encryption standards, and establishing a secure tunnel between the client and the web server. Once the TLS handshake is completed, the client and web server are able to communicate via a secure tunnel in which the payloads of the packets are encrypted between the client and the web server. Encrypted communications between the client and the web server are described in more detail below with reference to FIGS. 3A and 3B.

FIG. 3A illustrates communications between clients 302A and 302B and a web server 306 that pass through a proxy server 304. In the example of FIG. 3A, the upper client 302A communicates with the web server using HTTP (e.g., unencrypted communications 312A) and the lower client 302B communicates with the web server using HTTPS (e.g., encrypted communications 312B). Although not shown, it is assumed that in the case of the encrypted communications 312B, the client 302B and the web server 306 have performed the preliminary steps necessary to establish the encrypted communications as described above with reference to FIG. 2. With regard to the unencrypted communications (upper client), FIG. 3A illustrates that a username and a password are being communicated between the client and the web server as plaintext and with regard to the encrypted communications (lower client), FIG. 3A illustrates that ciphertext is being communicated between the client and the web server. For example, the ciphertext may be encrypted versions of the username and password from the upper client. In the example of FIG. 3A, the proxy server 304 through which the encrypted communications 312B pass is not able to decipher the ciphertext.

FIG. 3B depicts an example of a packet 314 that is used to communicate between the lower client (FIG. 3A, 302B) and the web server (FIG. 3A, 306) using HTTPS (e.g., an encrypted communication). As depicted in FIG. 3B, a frame format of the packet includes a header 316 that includes an IP header 318 and a TCP header 320 (e.g., a Transport layer header, such as the TCP header or a UDP header), and a payload 322 that includes a TLS portion 324 and an HTTP portion 326 (which may include content in HyperText Markup Language (HTML)). As is known in the field, when using HTTPS, the header 316 of the encrypted communication is unencrypted (e.g., plaintext) between the client and the web server and the payload 322 of the encrypted communication is encrypted (e.g., ciphertext) between the client and the web server. That is, the IP header and the TCP header are unencrypted and readable by a proxy server while being transmitted between the client and the web server and the TLS portion and the HTTP portion of the payload are encrypted and unreadable by a proxy server while being transmitted between the client and the web server. That is, the TLS portion and the HTTP portion of the payload are ciphertext that cannot be decoded by the proxy server (FIG. 3A, 304).

Referring back to FIG. 2, in a next set of communications corresponding to the wait time 217, the client 202 sends encrypted traffic (encrypted communications such as encrypted requests) to the web server 206 via the proxy server 204. For example, the client may send a GET request to the web server that includes a uniform resource locator (URL) which identifies content that the client would like to access at the web server. Because the communication is encrypted, the proxy server is only able to read the unencrypted portion of each packet, e.g., the IP header and the TCP header as described above with reference to FIG. 3B. In a next set of communications corresponding to the receive time 219, the web server returns information to the client in encrypted communications, e.g., in HTTPS responses. Again, because the communications are encrypted, the proxy server is only able to read the unencrypted portion of each packet, e.g., the IP header and the TCP header as described above with reference to FIG. 3B. Thus, through the operations described with reference to FIG. 2, the proxy server 204 facilitates the establishment and operation of a secure tunnel between the client 202 and the web server 206. Although an example of an encrypted GET request is described, other types of request, including, for example, POST, DELETE, PUT, PATCH, HEAD, OPTIONS, OR TRACE requests are possible types of requests in the encrypted requests.

The process described with reference to FIG. 2 may be repeated each time the client 202 makes a request to a different domain name. For example, the process described with reference to FIG. 2 is implemented when the client makes a request to the domain name example 1.com and the process described with reference to FIG. 2 is implemented again when the client makes a request to the domain name “example 2.com.” Likewise, the process described with reference to FIG. 2 is implemented when the client makes a request to the domain name “example.com” and the process described with reference to FIG. 2 is implemented again when the client is redirected by the web server to a different domain name, such as the subdomain “images.example.com.” As is known in the field, it is common for a web server to redirect a client to one or more different domain names in response to a request from the client.

As described above with reference to FIGS. 1-3B, with regard to an encrypted communication between a client and a web server, the proxy server can read any of the unencrypted communications and can read the header information of the encrypted communications, e.g., the IP header (e.g., source IP address and/or destination IP address) and the TCP header (e.g., source port, destination port, sequence number). However, because the proxy server is not able to decrypt any of the encrypted information in the payloads (e.g., in the TLS portion or in the HTTP portion) of the encrypted communications, the proxy server is not able to obtain any plaintext information from the encrypted information in the payloads of the encrypted communications. Although the proxy server is not able to decrypt the encrypted information, the proxy server is able to obtain some information about the communications between the client and the web server. For example, the proxy server can obtain information about the domain names that are requested by the client, the timing and/or patterns of unencrypted requests (e.g., a request for domain name “example.com,” followed by a request for a domain name “api.example.com”), and/or information about encrypted requests/responses, such as the size of the encrypted requests/responses, time related information about the encrypted requests/responses (e.g., request received time, response received time, timestamps, time instances).

IP proxy services provided through a proxy server, such as the proxy servers 104 and 204 described with reference to FIGS. 1 and 2, have been successful at avoiding IP-based bans by web servers. However, web servers have adapted to become more sophisticated at identifying undesired access requests. Banning a particular IP address from accessing a web server may involve, for example, the web server returning an HTTP response that includes an HTTP error code to the client or returning an HTTP response that redirects the client to another web server, such as a web server that presents a user login page or a Completely Automated Public Turing test to tell Computers and Humans Apart (CAPTCHA). Although the client may receive an HTTP response with an indication that there is a problem with the request to access the web server, the proxy server is not notified that the client has had any problem with the IP proxy service. Additionally, for communications between the client and the web server that are encrypted via HTTPS, the proxy server only has access to IP/TCP header information as plaintext while the payload is received as ciphertext. Thus, the proxy server is not able to read the payload of any encrypted communications between the client and the web server. Therefore, the proxy server cannot, for example, read an HTTPS response to know if the HTTPS response includes an HTTP error code or a redirect. However, it has been realized that even though many of the communications between the client and the web server are encrypted, it is possible for a proxy server to determine that access to a web server has been restricted in some way, such as by banning access to the web server from a particular IP address. For example, the proxy server can use information obtained from unencrypted information received at the proxy server (e.g., information about a pattern of requested domain names) and/or information obtained from the encrypted communications received at the proxy server (e.g., the size, timing, request/response patterns) to determine that access to the web server has been restricted. In one example, a method for operating a proxy server involves receiving at least one communication between a client and a web server, wherein the proxy server facilitates a secure tunnel between the client and the web server, determining from the at least one communication that access to the web server has been restricted, and implementing a remedial action in response to the restricted access determination. In one example, the proxy server can determine from the size of an encrypted response that access to the web server has been restricted, and in another example, the proxy server can determine from a pattern of unencrypted requests made by a client that access to the web server has been restricted, although these are just two examples.

Once it has been determined that access to a web server is restricted, some remedial action may be implemented by the proxy server. Remedial actions that can be implemented by a proxy server include, for example, changing the proxy IP address that is assigned to a client to a different proxy IP address, blocking the client from making additional requests using the same proxy IP address, adding a log entry to a banned log, updating a database of restriction determinations, notifying the corresponding customer that their activity has been restricted, and/or educating the customer on how to avoid future restrictions. In other examples, the proxy server implementing a remedial action may involve the proxy server sending a log entry to another server for addition to a banned log, sending a notification to a database server to update a database of restriction determinations, providing a message to notification system to trigger notification of the corresponding customer that their activity has been restricted, and/or triggering a process of educating the customer on how to avoid future restrictions. Although some examples of remedial actions are provided, other types of remedial actions may be implemented by the proxy server to, for example, improve the IP proxy service and/or to correct some problem with the IP proxy service. By determining that access to a web server has been restricted for a particular client and taking some remedial action, such as changing the proxy IP address that is assigned to the client, in response to the determination, an IP proxy service can provide an improved customer experience.

In an example implementation of an IP proxy service, machine learning (ML) techniques can be applied to identify patterns in communications between a client and a web server which indicate that access to the web server has been restricted. For example, supervised learning techniques can be applied to communications between clients and web servers to produce models that are trained to predict when access to a web server has been restricted, where the predictions are made from information that is available from the communications that pass through a proxy server.

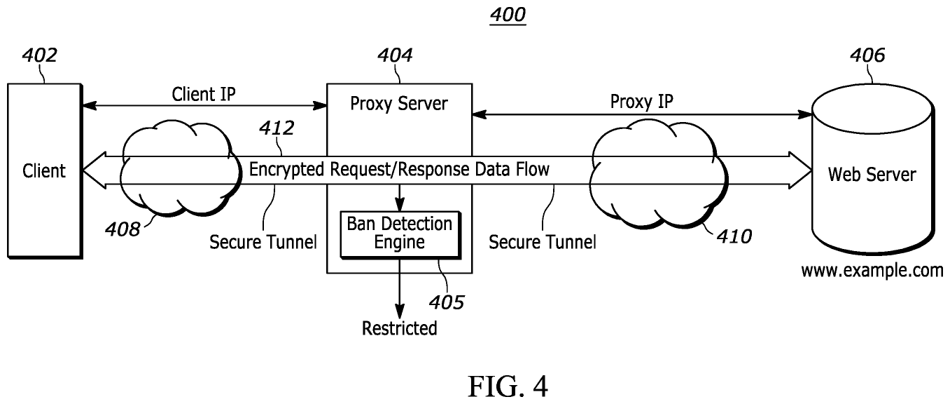

FIG. 4 illustrates an example operation of an IP proxy service in a network 400 in which the proxy server 404 includes a ban detection engine 405 configured to determine from communications between the client 402 and web server 406 that access to the web server 406 has been restricted. Because many of the communications 412 between the client 402 and the web server are encrypted as described above, the proxy server can use information obtained from the unencrypted communications and/or information obtained from the encrypted communications but the proxy server cannot decrypt information in the payloads of the encrypted communications to make such a decision. Rather, the proxy server relies on information about the communications that can be obtained at the proxy server such as information about the domain names that are requested by the client, the timing and/or patterns of unencrypted requests (e.g., a request for domain name “example.com,” followed by a request for a domain name “api.example.com”), and/or information about encrypted requests/responses, such as the size of the encrypted requests/responses, time related information about the encrypted requests/responses (e.g., request received time, response received time, timestamps, time instances), or some combination thereof to determine whether or not a web server has restricted a client's access to the web server.

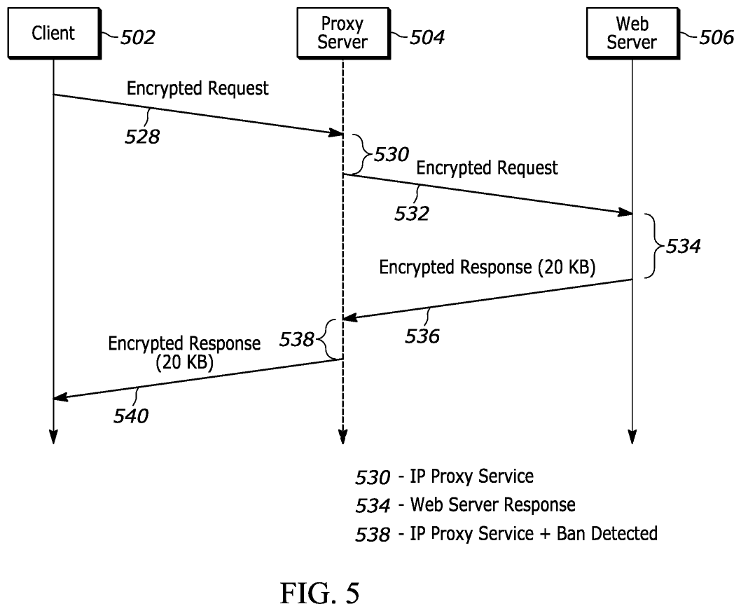

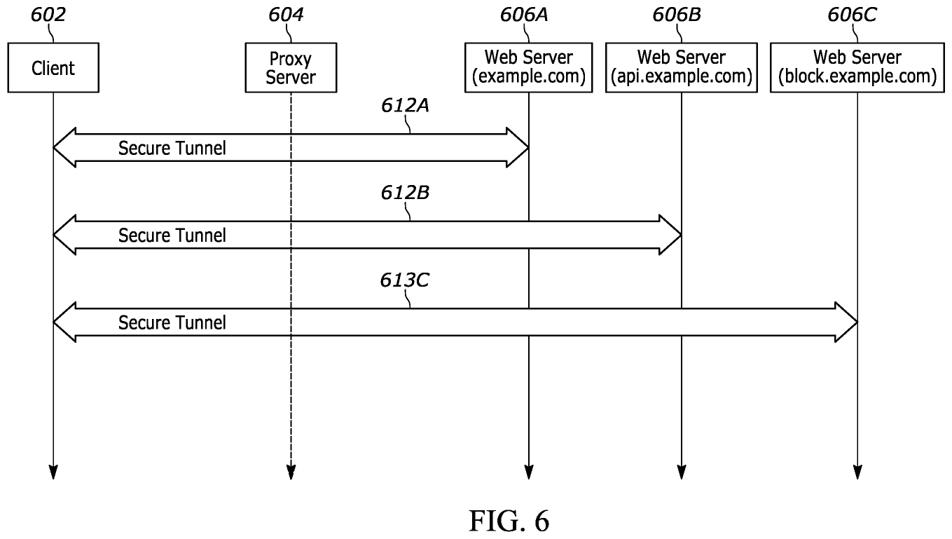

The information that is obtained from the communications that are received at the proxy server, whether obtained from unencrypted communications or from encrypted communications, can be used by the ban detection engine of the proxy server to determine if access to the web server has been restricted. Some examples of how such information can be used to determine if access to the web server has been restricted are described with reference to FIGS. 5 and 6. In particular, FIG. 5 illustrates an example in which the proxy server determines from the size of an encrypted response, or responses, that access to the web server has been server has been restricted, and FIG. 6 illustrates an example in which the proxy server determines from a pattern of unencrypted requests made by a client that access to the web server has been restricted,

FIG. 5 is a timeline of encrypted communications between a client 502 and a web server 506 that pass through a proxy server 504. With reference to FIG. 5, in a first operation 528, the client sends an encrypted request (e.g., an HTTPS request such as a GET, POST, DELETE, PUT, or PATCH request) to the web server and the encrypted request is received at the proxy server. Because the request is encrypted, the IP header and the TCP header of the request are received at the proxy server as plaintext and the payload of the request, including the TLS portion and the HTTP portion, are received at the proxy server as ciphertext. In a next operation 530, the proxy server implements an IP proxy service by, for example, replacing the source IP address of the request with a proxy IP address. For example, the proxy IP address is selected from a pool of proxy IP addresses that is maintained by the proxy server. In a next operation 532, the proxy server sends the encrypted request, with the proxy IP address as the source IP address and the web server IP address as the destination IP address, to the web server. In a next operation 534, the web server processes the encrypted request and then sends an encrypted response (operation 536) using the received source IP address as the destination IP address in the response. In the example of FIG. 5, the web server has restricted access to the web server based on some aspect of the received encrypted request. For example, the web server has identified the source IP address as an IP address that is provided from an proxy server, or the web server has identified the source IP address as bad for some other reason, e.g., too many access requests from the same IP address. As a result of the restriction, the web server returns an encrypted response that has a destination IP address that is the proxy IP address (i.e., the source IP address of the request), a source IP address of the web server (e.g., an IP address that corresponds to the domain name of “example.com”), and a size of, for example, 20 KB. In a next operation 538, the proxy server receives the encrypted response, which is 20 KB in size, and determines from the size of the encrypted response that access to the web server has been restricted. For example, the proxy server is able to determine from the size of the encrypted response that access to the web server has been restricted because the size of the encrypted response is much smaller than the size of an encrypted response that would be expected in a typical encrypted response, e.g., a typical encrypted response in which access is not restricted by the web server. In an example, the ban detection engine (FIG. 4, 405) of the proxy server can examine log files to identify response sizes that are indicative of a ban. In another example, the ban detection engine of the proxy server determines that access to the web server has been restricted by recognizing a change in the size of encrypted responses received at the proxy server in response to a particular encrypted request. For example, the proxy server may receive multiple encrypted responses corresponding to a request from a particular client of a first size (e.g., 300 KB) and then recognize a change in a subsequent encrypted response corresponding to the same client to a second size (e.g., 20 KB), where the change in size from the first size to the second size across encrypted responses is an indication that access to the web server has been restricted for that client, and thus for the corresponding proxy IP address.

Once the proxy server 504 has determined that access to the web server 506 has been restricted for the particular client (and thus the corresponding proxy IP address), the proxy server can take some remedial action such as switch the client to a different proxy IP address. Additionally, once the proxy server has determined that access to the web server has been restricted (e.g., banned), the proxy server can implement an additional remedial action that involves linking the restriction to the particular proxy IP address that was used as the destination IP address for the response and may, for example, involve adding the proxy IP address to an internal banned list, or otherwise marking the proxy IP address as having been associated with a restriction.

Referring again to FIG. 5, in a next operation 540, the proxy server 504 sends the encrypted response to the client 502 using the client IP address as the destination IP address and using the same source IP address as was used by the web server, e.g., the source IP address that corresponds to the domain name “example.com.” Thus, as illustrated in FIG. 5, the proxy server is able to determine that access to the web server has been restricted even though the request and response received at the proxy server were encrypted communications such that only the IP header and the TCP header are readable by the proxy server. Because the proxy server is able to determine that access to the web server has been restricted, the proxy server is able to take some remedial action that can improve the performance of the IP proxy service, such as changing the proxy IP address for subsequent requests, thereby avoiding another ban and improving the customer experience/satisfaction with the IP proxy service.

In the example of FIG. 5, the size of the response is an indication that access to the web server has been restricted. In another example, a lack of a response being received at the proxy server 504 after a request has been sent from the proxy server may be an indication that access to the web server 506 has been restricted. For example, after the proxy server sends the encrypted request 532, the proxy server 504 may expect to receive a response (e.g., encrypted response 536) from the web server 506 and a lack of any response, particularly within some threshold time period (e.g., 10 seconds), may be used to determine that access to the web server with respect to that particular request has been restricted.

FIG. 6 is a timeline of secure tunnels 612A, 612B, and 612C that are established between a client 602 and multiple web servers 606A, 606B, and 606C, respectively, that pass through a proxy server 604. With reference to FIG. 6, in a first operation, the client and web server 606A communicate with each other via the secure tunnel 612A using the process as described above with reference to FIG. 2. As described above with reference to FIG. 2, the client sends an unencrypted CONNECT request to the proxy server that includes the domain name of the targeted web server (e.g., example.com). In the example of FIG. 6, the encrypted communications between the client and the web server 606A triggers the client to establish a new secure tunnel between the client and the web server 606B. With reference to FIG. 6, in a second operation, the client and web server 606B communicate with each other via the secure tunnel 612B using the process as described above with reference to FIG. 2. As described above with reference to FIG. 2, the client sends an unencrypted CONNECT request to the proxy server that includes the domain name of the targeted web server (e.g., api.example.com). In the example of FIG. 6, the encrypted communications between the client and the web server 606B triggers the client to establish a new secure tunnel between the client and the web server 606C. For example, some communications of the client cause the client to be redirected to a login page (e.g., a CAPTCHA). With reference to FIG. 6, in a third operation, the client and web server 606C communicate with each other via the secure tunnel 612C using the process as described above with reference to FIG. 2. As described above with reference to FIG. 2, the client sends an unencrypted CONNECT request to the proxy server that includes the domain name of the web server (e.g., the login domain of block.example.com). Thus, in this example, the web server example.com has restricted access to the web server by redirecting the client to a login page, e.g., at block.example.com. In an example, the ban detection engine (FIG. 4, 405) of the proxy server is configured to recognize the pattern of requests from the client, e.g., example.com followed by api.example.com, followed by block.example.com as a pattern that is indicative of an access restriction.

Once the proxy server 604 has determined that access to the web server 606A has been restricted, the proxy server can take some remedial action such as switch the client 602 to a different proxy IP address for subsequent access requests to the web server 606A. Additionally, once the proxy server has determined that access to the web server 606A has been restricted (e.g., banned), the proxy server can take some remedial action such as link the restriction to the particular proxy IP address that was used for the client and may, for example, add the proxy IP address to an internal banned list, or otherwise mark the proxy IP address as having been associated with a restriction. Thus, as illustrated in FIG. 6, the proxy server is able to determine that access to the web server has been restricted even though the client and web server utilize secure tunnels to exchange encrypted communications. Because the proxy server is able to determine that access to the web server has been restricted, the proxy server is able to take some remedial action that can improve the performance of the IP proxy service, e.g., changing the proxy IP address for subsequent requests to avoid additional disruptions, thereby improving the customer experience/satisfaction with the IP proxy service.

In the example of FIG. 5, the determination of restricted access is made by the proxy server 504 in response to information obtained from encrypted communications (e.g., the size of an encrypted response) and in the example of FIG. 6, the determination of restricted access is made by the proxy server 604 in response to information obtained from unencrypted communications (e.g., from the pattern of domain names in a series of unencrypted requests). Although in the examples of FIGS. 5 and 6, the determination about restricted access is made in response to a single piece of information (e.g., the size or the pattern), the determination about restricted access may be made in response to multiple pieces of information including, for example, multiple pieces of information obtained from encrypted communications, multiple pieces of information obtained from unencrypted communications, or a combination of information obtained from encrypted information and information obtained from unencrypted information. Additionally, although the examples of FIGS. 5 and 6 are specific to information obtained from a response received from the web server or a sequence of requests received from the client, a determination of restricted access may be made in response to information obtained only from a response, in response to information obtained only from a request, or requests, in response to information obtained from a combination of information from a request and from a response, or in response to information obtained from multiple requests and/or from multiple responses. Additionally, although some examples of information used to determine that access to a web server has been restricted are provided, other information related to communications between a client and a web server that utilize a proxy server can be used to determine that access to a web server has been restricted.

The examples described above with regard to FIGS. 5 and 6 relate to cases in which the proxy server determines that access to the web server has been restricted based on some communications received at the proxy server. That is, the proxy server determines that the web server has restricted access based on information obtained from communications received at the proxy server. In other examples, it may be desirable for the proxy server to determine that access to the web server will be, or is likely to be, restricted, e.g., before the web server has actually restricted access. For example, it may be desirable to predict that access to a web server will be, or is likely to be, restricted so that some remedial action can be taken in advance of the restriction actually happening, such as changing the proxy IP address assigned to a client before a request is sent by the client in hopes of avoiding an actual restriction altogether.

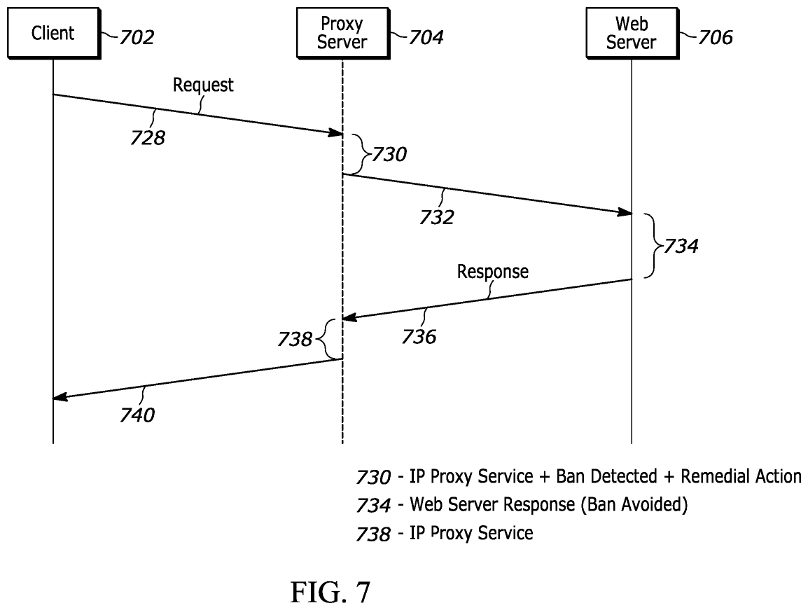

FIG. 7 is another timeline of operations between a client 702, a proxy server 704, and a web server 706. With reference to FIG. 7, in a first operation, the client sends an unencrypted request 728 (e.g., a CONNECT request) to the proxy server. Because the request is sent to the proxy server as plaintext, the proxy server is able to read the CONNECT request and learn the domain name that is the target of the request. In a next operation 730, the proxy server determines from the CONNECT request that access to the web server may be restricted. For example, the proxy server may predict that access to the web server may be, or is likely to be, restricted using a predictive model that is generated based on previous training. In one example, the proxy server may recognize that the proxy server has received a high number of CONNECT requests to the same web server from the same client over some predetermined time interval. Once the proxy server predicts that access to the web server may be, or is likely to be, restricted for the client, the proxy server takes some remedial action. For example, the proxy server may change the proxy IP address that is assigned to the client to a different proxy IP address to avoid a subsequent access restriction (e.g., an access ban) by the web server. In a next operation 732, the proxy server sends the request, with the changed proxy IP address as the source IP address and the web server IP address as the destination IP address, to the web server. In a next operation 734, the web server processes the request and then sends a response (operation 736) using the received source IP address as the destination IP address in the response with no access restriction. In operation 738, the proxy server 704 processes the response and sends the response (operation 740) to the client. In an operation 740, the proxy server sends the response to the client using the client IP address as the destination IP address and using the same source IP address as was used by the web server. Thus, by predicting that a ban by the web server was imminent or at least likely, the proxy server can take some preemptive action to avoid an access restriction. As illustrated in FIG. 7, the proxy server is able to predict that access will be, or is likely to be, restricted and take some remedial action to avoid such a restriction from actually occurring.

In another example, a determination that access to a web server has been restricted may be made at the proxy server based on the communications that are involved in establishing a secure tunnel. With reference to FIG. 2, the proxy server 204 may determine that access to the web server 206 has been restricted, or is likely to be restricted, based on communications that occur before the secure tunnel is established, e.g., during the TLS handshake, see TLS time 215. For example, an access restriction may be put in place by the web server if the web server detects a suspicious activity based on a TLS fingerprint (e.g., specific TLS parameters, or order of TLS parameters, that do not match a typical browser), and such an access restriction can be identified based on the messages seen at the proxy server during the TLS handshake.

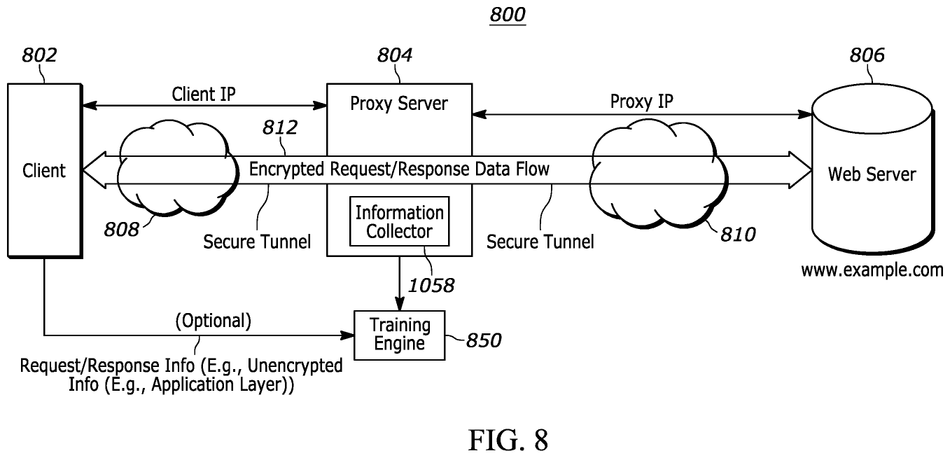

As described herein, it has been realized that there are some types of information obtained from unencrypted communications and/or obtained from encrypted communications received at a proxy server that can be used at the proxy server to determine that access to a web server has been restricted. However, it has also been realized that there are likely other types of information that can be obtained from unencrypted communications and/or from encrypted communications received at a proxy server that can be used by the proxy server to predict when access to a web server has been restricted. Thus, in an example, machine learning concepts are applied to learn characteristics of information obtained from unencrypted communications and/or from encrypted communications received at a proxy server that can be used by the proxy server to predict when access to a web server has been restricted. FIG. 8 illustrates an example training operation for an IP proxy service in a network 800 in which a proxy server 804 provides a proxy IP address to the client 802 for accessing the web server 806. The network as described with reference to FIG. 8 is similar to the network 400 as described with reference to FIG. 4, with the client, the web server, and the proxy server performing operations similar to those described above. In addition to the network components as described above, in an example, the proxy server includes an information collector 1058 that is configured to collect relevant information from the proxy server and the network includes a training engine 850 that is configured to receive information from the proxy server. In an example, information received at the training engine from the proxy server may include information about the domain names that are requested by the client, the timing and/or patterns of unencrypted requests (e.g., a request for domain name “example.com,” followed by a request for a domain name “api.example.com”), and/or information about encrypted requests/responses, such as the size of the encrypted requests/responses, time related information about the encrypted requests/responses (e.g., request received time, response received time, timestamps, time instances), or some combination thereof. Further, any information that can be obtained by the proxy server from the communications described with reference to FIG. 2 can be used as training data. In an example, the training engine 850 may accumulate information received from the proxy server 804 as training data. In one example, training data is accumulated on a per packet, or per flow basis although other approaches may be used. Additionally, although only one client, one proxy server, and one web server 806 are shown in FIG. 8, information may be accumulated from multiple different clients, from multiple different proxy servers, and from multiple different web servers. In addition, as shown in FIG. 8, the training engine may be separate from the proxy server. For example, the training engine may be implemented on a different server. In other examples, a training engine may be implemented on a proxy server, or some connected server to implement ongoing training as new training information is collected.

In an example, the training engine 850 is configured to process the training data to produce a model, or models, that can predict whether access to a web server has been restricted or whether access to a web server may be restricted, e.g., at some point in the future. For example, the training engine may utilize known machine learning algorithms that involve linear regression, logistic regression, decision trees, support vector machines, Naïve Bayes algorithm, K-Nearest Neighbors algorithms, K-means algorithms to generate a model, or models, that can be used to make inferences.

In some examples, the training engine 850 receives information only from the proxy server 804, or proxy servers. In other examples, the training engine may receive information from a client or clients that use an IP proxy service that is provided by a proxy server in the network. Thus, FIG. 8 also illustrates that training data may be supplied to the training engine from the client 802. In an example, information received from the client 802 may include domain name information, size information, timing information, request/response patterns, and/or a combination thereof. In addition, the information received from the client may optionally include unencrypted information from the payloads of HTTPS requests (encrypted requests) and decrypted information from the payloads of the HTTPS responses (encrypted responses). For example, decrypted information, including Application Layer information such as a HTTP codes in HTTPS responses, may be provided from the client to the training engine. In an example, HTTP codes provided to the training engine from the client may be used as ground truths to indicate whether or not access has been restricted by a web server. For example, a decrypted HTTP code of “200” in an HTTPS response from a web server may indicate that access to the web server has not been restricted while a decrypted HTTP code of “404” in an HTTPS response from the web server may indicate that access to the web server has been restricted. Other information may be used as ground truths with regard to whether or not access to a web server has been restricted. For example, an HTTP request (unencrypted CONNECT request) to a login page may be an indication that access to a web server has been restricted.

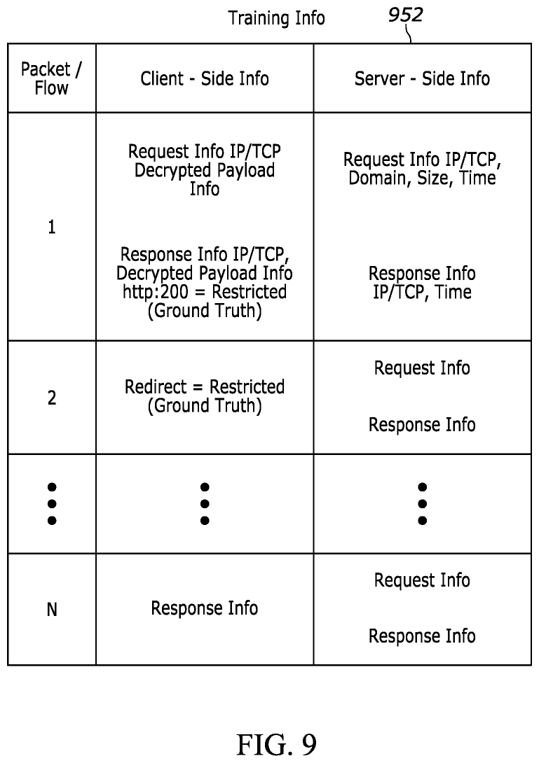

In one example, training data is accumulated on a per packet, or per flow basis. FIG. 9 is an example table 952 of training data that may be accumulated by the training engine (FIG. 8, 850). In the example of FIG. 9, the first column corresponds to a specific packet or specific packets, and/or to a flow of packets (e.g., where a flow is defined by a common 5-tuple of source/destination IP address, source destination port number, and IP protocol), the second column corresponds to client-side information (e.g., information supplied by a client or multiple clients), and the third column corresponds to server-side information (e.g., information supplied by an IP proxy server or by multiple IP proxy servers). Although the table in FIG. 9 is provided as an example, training data may be accumulated and stored in various different ways. For example, training data may be accumulated in a database of training data.

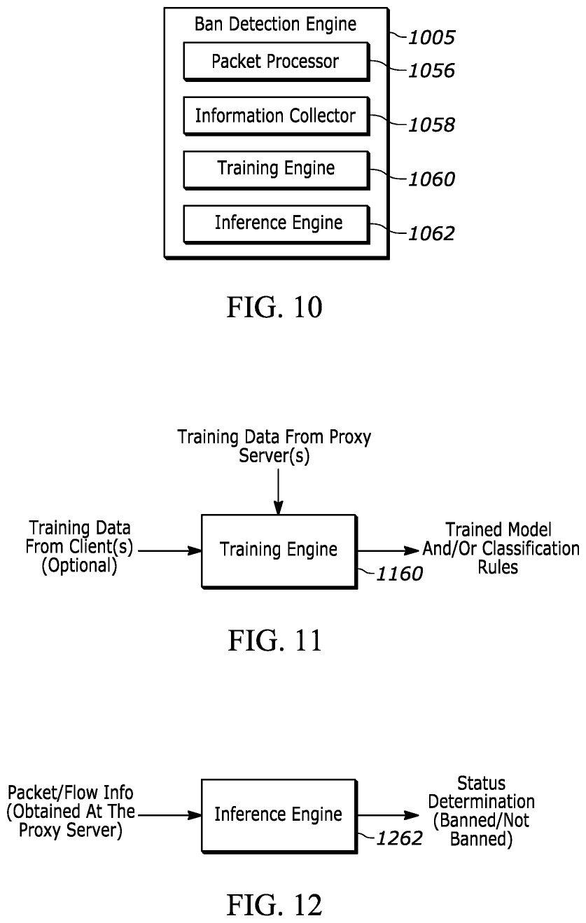

FIG. 10 depicts a functional block diagram of an example of a ban detection engine 1005 such as the ban detection engine 405 (FIG. 4). The ban detection engine includes a packet processor 1056, an information collector 1058, a training engine 1060, and an inference engine 1062. In an example, the packet processor is configured to implement parsing, timing tracking, and traffic counting (e.g., counting volumes of traffic). The information collector is configured to implement the collection of statistics related to communications that are received at the proxy server. In an example, the collected statistics can be used for machine learning training and/or machine learning inference operations. In an example, the training engine is configured to implement machine learning based training using data collected by the information collector. For example, the training engine may utilize known machine learning algorithms that involve linear regression, logistic regression, decision trees, support vector machines, Naïve Bayes algorithm, K-Nearest Neighbors algorithms, K-means algorithms to generate a model, or models, that can be used to make inferences. In some examples, the training is centralized at one training engine, in some embodiments, the training may be distributed to training engines throughout a network, or the training could be a combination of localized and distributed training. In an example, the inference engine is configured to implement machine learning based inferences based on information gleaned from communications that are processed at a proxy server. For example, the inference engine may utilize known machine learning algorithms that involve linear regression, logistic regression, decision trees, support vector machines, Naïve Bayes algorithm, K-Nearest Neighbors algorithms, K-means algorithms to generate inferences related to communications that are processed at a proxy server. The packet processor, information collector, training engine, and inference engine of the ban detection engine can be implemented in a proxy server in software, hardware, firmware, or some combination thereof. In some examples, the ban detection engine may be configured to store and implement rules to implement certain ban detection logic. For example, the ban detection engine may be configured to store and implement ban detection rules that implement some ban detection logic as described with reference to FIGS. 5 and 6. The ban detection engine may be configured to implement different ban detection logic/rules.

FIG. 11 illustrates an example of a training operation that is implemented at a training engine 1160 such as the training engine 1060 of FIG. 10. As shown in FIG. 11, the training engine may receive training data from a proxy server, or proxy servers. This training data may include information obtained from unencrypted communications and/or information obtained from encrypted communications. The training engine may also receive training data from a client or clients. This training data may include information obtained from unencrypted communications, information obtained from encrypted communications, and/or information obtained from decrypted communications. The training engine outputs a trained model and/or classification rules based on the received training data. In an example, training operations may involve matching client-side info (e.g., including unencrypted info) with proxy-side info (e.g., from unencrypted communications and/or from encrypted communications) for communications between clients and web servers. The training operation can be implemented by a proxy server, or the training operation can be implemented by some other server.

FIG. 12 illustrates an example of an inference operation that is implemented at an inference engine 1262 of a proxy server such as the inference engine 1062 of the ban detection engine 1005 of FIG. 10. As shown in FIG. 12, the inference engine receives some information that is obtained at the proxy server and related to at least one communication received at the proxy server. Since some of the communications processed at the proxy server are encrypted, the information related to the communications is limited to information that can be obtained from the unencrypted communications and/or information that can be obtained from the encrypted communications. The inference engine uses information related to the at least one communication as an input and applies the information to a trained model, such as a model trained by the training engine. For example, the inference engine may be configured to generate a feature vector from the communications corresponding to a particular client and apply the feature vector to a trained model. In an example, a feature vector may include some values related to the size (e.g., in KB) and timing of an encrypted communication. The inference engine outputs a status determination with regard to a particular communication. For example, the status determination is a prediction as to whether or not access to a web server by a client has been restricted, or may be (or is likely to be) restricted. In an example, training and/or inference operations may involve information related to a domain name in a request/response, a pattern of domain names in requests, a size of a request/response, a change in size of request/response, time information (response time, timestamp), a request/response pattern, from request-based information only, from response-based information only, from a combination of request/response based info, from a multi-variant feature vector (e.g., domain, size, and/or time).

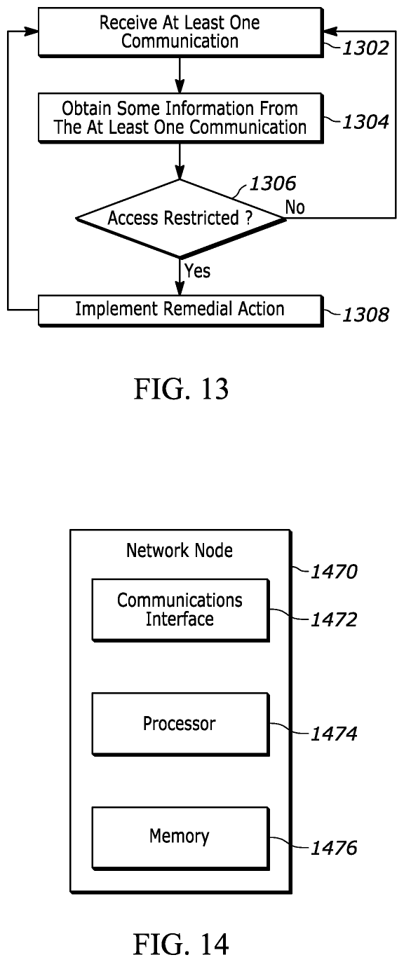

FIG. 13 is a process flow diagram of operations that may be performed at a proxy server such as the proxy server described herein. At block 1302, at least one communication is received at a proxy server. For example, the at least one communication is a communication as described above with reference to FIG. 2. At block 1304, some information is obtained from the at least one communication. For example, the information that is obtained from the at least one communication may include a domain name in a request/response, a pattern of domain names in requests, a size of a request/response, a change in size of request/response, time information (response time, timestamp), a request/response pattern, from request-based information only, from response-based information only, from a combination of request/response based info. At decision point 1306, it is determined from the obtained information if access to a web server has been restricted. For example, a ban detection engine of a proxy server may apply to some ban detection logic to the obtained information to make such a determination. In an example, the ban detection logic may include a ban detection rule set and/or logic implemented by an inference engine. If it is determined that access to the web server is not restricted, then the process returns to block 1302. However, if it is determined that access to the web server is restricted, then the process proceeds to block 1308 and a remedial action is implemented. After the remedial action is implemented, the process returns to block 1302.

In an embodiment, the above-described functionality is performed at least in part by a computer or computers, which executes computer readable instructions. FIG. 14 depicts an example of a computer, referred to herein as a network node, that can implement the operations of an IP proxy server as described herein. As shown, the network node 1470 includes a communications interface 1472, a processor 1474, and a memory 1476. The processor may include a multifunction processor and/or an application-specific processor. As an example, the processor could be a central processing unit (CPU) (with software), an application-specific integrated circuit (ASIC), a transceiver, a radio, or a combination thereof. The memory within the computer may include, for example, storage medium such as read only memory (ROM), flash memory, random access memory (RAM), and a large capacity permanent storage device such as a hard disk drive. The communications interface enables communications with other computers via, for example, the Internet Protocol (IP). The computer executes computer readable instructions stored in the storage medium to implement various tasks as described above.

As used herein, restricted access to a web server may include, for example, access to a web server being completely banned or blocked (e.g., for a particular IP address), access to a web server being partially banned (e.g., only a portion of the requested content is returned), requests for access to a web server being dropped/ignored by a web server, a client being redirected to a different domain name (or subdomain) (e.g., redirect to a login page or CAPTCHA), or some performance degradation, such as reduced download speed or a limited number of accesses. Although some examples of restricted access are provided, other instances of restricted access are possible.

Additional description of information that may be used to identify an access restriction (e.g., from a training and/or inference perspective), including when access has been restricted and/or when access may be restricted, is provided below. In an example, information that may be collected with regard to communications between a client and a web server include: 1) the domain the client connects to (e.g., example.com) but not the exact URL (e.g., example.com/login, because the request (e.g., GET, POST, DELETE, PUT, PATCH, etc.) cannot be read in the encrypted communications); 2) size (e.g., in bytes) of an encrypted request that is made by the client; 3) size of an encrypted response that is received from the web server; 3) response time (e.g., time taken by the web server to respond to a request); 4) timestamp of the request (may be useful to define the connection between requests); 5) subsequent CONNECT requests made by a client (e.g., if the request was made to www.example.com, and right away to api.example.com—this data might be important).

In an example, the domain name in a CONNECT request is a data point and can be used by a proxy server to identify a general case (e.g., behavior and requirements of the web server for domain name example 1.com may be drastically different from the behavior and requirements of the web server for domain name example 2.com).

The domain name that is received as plaintext at a proxy server may also be important in two other ways, including for example:
a) requests to subdomains (e.g., CONNECT requests received at a proxy server as plaintext) often reveal information about what the client is requesting. For example, www.searchengine.com is often requested for scraping search results while accounts.searchengine.com is used to access an account, which may be a red flag in the context of providing an IP proxy service.
b) requests to subdomains (e.g., CONNECT requests received at a proxy server as plaintext) together with a timestamp may help define subsequent requests by showing the context of subsequent requests. For example, a CONNECT request to m.media-shoppingwebsite.com happening within <1 s after a CONNECT request to www.shoppingwebsite.com may be related to a webpage being rendered and images from that product webpage being loaded. While a CONNECT request to www.searchengine.com made <1 s after a CONNECT request to www.shoppingsite.com is unlikely related, and may be a sign of parallel access operations implemented by a client with use of the same proxy IP address. Thus, the domain name, or subdomain, associated with a request (e.g., CONNECT requests received at a proxy server as plaintext) can be a useful indicator as to whether or not access to a web server has been restricted.

In an example, the size of an encrypted request (e.g., a GET request) that is received at a proxy server from a client may provide useful information with regard to identifying an access restriction, e.g., some web servers do not return a successful response to a request having no headers or user-agent at all. Such encrypted requests may have a relatively small request size (e.g., dozens of bytes), compared to properly defined encrypted requests (e.g., a few kB). On the contrary, if an encrypted request is too big (e.g., a few MBs), this may indicate that the client is attempting to upload something, which may be ok for some web servers (e.g., automated image processing), but not ok for other web servers (e.g., trying to implement a Distributed Denial of Service (DDOS) attack on a search site, e.g., www.searchengine.com). Thus, the size of an encrypted request that is received at a proxy server can be a useful indicator as to whether or not access to a web server has been restricted, or may be restricted upon receipt of the request.

In an example, the size of an encrypted response received at a proxy server from a web server may provide useful information. For example, a product page of a shopping website may be a few hundred KBs while a CAPTCHA may be only about 8 KB, which can be clue as to whether or not access to the web server has been restricted. If the same web server returned instead an error message (e.g., “sorry, something went wrong”), the encrypted response may be a bit larger, such as 12 KB. In yet another example, the web server may return a redirect in an encrypted response, which may be <1 KB. Thus, the size of an encrypted response that is received at a proxy server can be a useful indicator as to whether or not access to a web server has been restricted.

In addition, while any one feature of an encrypted communication received at a proxy server may provide some indication as to whether or not access to a web server has been banned, or will be banned, multiple features considered together may be provide a more reliable indication as to whether or not access to a web server has been banned, or will be banned. For example, information about the size of an encrypted response in combination with information about the timing of the encrypted response (e.g., the amount of delay measured at the proxy server) can provide a strong indication of whether or not access to a web server has been restricted.

In an example, ban detection at a proxy server may involve a log analysis operation that calculates a relationship of the size of a received request to the size of a received response, and when a ratio is greater than 0.1, then the communication should be verified. For example, the proxy server itself can open a connection to the same web server, using the same proxy IP address and will thus likely receive the same HTTP code in a response, indicating a failure, or a page that contains text such as “access is denied,” which serves as a verification that the IP address assigned to a client has been restricted.

In an example, a pattern of requests from the same client can provide a strong indication of whether or not access to a web server has been restricted. For example, a large number of subsequent requests from the same client may reveal the way the client accesses web servers (e.g., via single-request tools like cURL, or via full-rendering tools like headless browsers). Such information can be useful to define the best way to support the client and make the client's requests more successful. For example, cURL requests typically generate subsequent requests if the client has been redirected by a web server. In another example, cURL may not generate subsequent requests, while the client (e.g., browser, even a headless browser) may generate a subsequent in a case in which the web server sent a redirect.

In another example, most types of pages on each web server typically trigger a specific pattern of subsequent requests by the client. For example, a product webpage may involve a sequence of requests (e.g., unencrypted CONNECT requests) such as:
1) www.shoppingsite.com (the page itself);
2) product-images.shoppingsite.com (for loading product images); and
3) xml.shoppingsite.com (for loading XML info of the product).
   While the login page for the same shopping site may involve a sequence of requests (e.g., unencrypted CONNECT requests) such as:
1) www.shoppingsite.com;
2) users.shoppingsite.com (for checking if the user already logged in);
3) captcha.shoppingsite.com (for loading a captcha for the signup page to avoid bots).

It is noted that there are many different types of web pages, each having potentially different patterns that can be seen by a proxy server. Such pattern information may help not only to define if a request was successful and legitimate, but also to provide information on the type of a page so that sets of rules and/or configurations can be applied at a proxy server based not just on the domain name seen at the proxy server but also on a page type.

In an example, the number of requests received at a proxy server from a client over some time interval may be useful to define if the request was blocked simply due to too many requests being made to the same domain from the same proxy IP address in a short period of time. In such a case, even a proper request to a proper web server might be blocked by the corresponding web server, and quite often it may even result in a continuous block for some amount of time (e.g., some number of hours). Additionally, the number of hours of a block may be different for different websites, and knowledge of the durations may be useful.

While some information/parameters that can be obtained by a proxy service provider from requests/responses (including unencrypted and/or encrypted requests/responses) received at a proxy server may be useful in determining at the proxy server if access to a web server has been restricted or may be restricted, the accuracy and utilization of such determinations may be improved with more training data and by continually updating the training data with current information to identify changes in patterns or new patterns that may develop.

In an example, a proxy server is not only able to determine whether or not access to a web server has been restricted, but what type of restriction on access has been exercised. For example, the proxy server is able to determine from information that can be obtained from the requests/responses whether access to a web server has been banned (e.g., for a particular IP address), whether a request to a web server is being dropped/ignored, and/or whether a request for access to a web server is being redirected (e.g., to a login page or CAPTCHA). In an embodiment, the training information includes information about the type of restriction that has been encountered so that the type of restriction can be learned and a trained model implemented at a proxy server can provide predictions about the type of restriction, e.g., in addition to whether or not a restriction has been put in place or is expected to be put in place.

The proxy servers described with reference to FIGS. 2-13 may be a single server computer, or the proxy server may include multiple computing devices that are operatively coupled to each other by, for example, a LAN and/or a WAN, which, operating together provide an IP proxy service to clients. Thus, a proxy server that runs a ban detection engine may be distributed amongst multiple different computing devices. For example, one computing device of the proxy server may manage proxy IP addresses while a different computing device of the proxy server manages determining whether or not access has been restricted, while still a different computing device of the proxy server implements a remedial action, such as notifying a customer about an access restriction.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It is understood that the scope of the protection for systems and methods disclosed herein is extended to such a program and in addition to a computer readable means having a message therein, such computer readable storage means contain program code means for implementation of one or more steps of the method, when the program runs on a server or mobile device or any suitable programmable device.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the above-described techniques are described in a general context, those skilled in the art will recognize that the above-described techniques may be implemented in software, hardware, firmware, or a combination thereof. The above-described embodiments of the invention may also be implemented, for example, by operating a computer system to execute a sequence of machine-readable instructions. The instructions may reside in various types of non-transitory computer readable media. In this respect, another aspect of the present invention concerns a programmed product, comprising computer readable media tangibly embodying a program of machine-readable instructions executable by a digital data processor to perform the method in accordance with an embodiment of the present invention.

The non-transitory computer readable media may comprise, for example, random access memory (not shown) contained within the computer. Alternatively, the instructions may be contained in another non-transitory computer readable media such as a magnetic data storage diskette and directly or indirectly accessed by a computer system. Whether contained in the computer system or elsewhere, the instructions may be stored on a variety of machine-readable storage media, such as a direct access storage device (DASD) storage (e.g., a conventional “hard drive” or a Redundant Array of Independent Drives (RAID) array), magnetic tape, electronic read-only memory, an optical storage device (e.g., CD ROM, WORM, DVD, digital optical tape), paper “punch” cards. In an illustrative embodiment of the invention, the machine-readable instructions may comprise lines of compiled C, C++, or similar language code commonly used by those skilled in the programming for this type of application arts.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for operating a proxy server, the method comprising:
receiving at least one communication between a client and a web server, wherein the proxy server facilitates a secure tunnel between the client and the web server;
determining from the at least one communication that access to the web server has been restricted; and
implementing a remedial action in response to the restricted access determination.

2. The method of claim 1, wherein determining from the at least one communication that access to the web server has been restricted involves identifying a size of the at least one communication and determining that access to the web server has been restricted in response to the size of the at least one communication.

3. The method of claim 1, wherein the at least one communication is an encrypted communication, and wherein determining from the at least one communication that access to the web server has been restricted involves identifying a size of the encrypted communication and determining that access to the web server has been restricted in response to the size of the encrypted communication.

4. The method of claim 1, wherein the at least one communication is an encrypted communication, and wherein determining from the at least one communication that access to the web server has been restricted involves identifying that a size of the encrypted communication is smaller than an expected size and determining that access to the web server has been restricted in response to identifying that a size of the encrypted communication is smaller than an expected size.

5. The method of claim 1, wherein determining from the at least one communication that access to the web server has been restricted involves identifying a domain name from the at least one communication and determining that access to the web server has been restricted in response to the identified domain name.

6. The method of claim 1, wherein determining from the at least one communication that access to the web server has been restricted involves identifying a pattern of domain names from multiple communications and determining that access to the web server has been restricted in response to the identified pattern of domain names.

7. The method of claim 1, wherein determining from the at least one communication that access to the web server has been restricted involves generating a feature vector from the at least one communication and applying the feature vector to a trained model.

8. The method of claim 1, wherein:
a proxy IP address is used as the source IP address over a portion of the at least one communication that is between the proxy server and the web server for a request from the client; and
the proxy IP address is used as the destination IP address over a portion of the communication that is between the proxy server and the web server for a response from the web server.

9. The method of claim 8, wherein the proxy IP address is provided by the proxy server.

10. The method of claim 1, wherein the remedial action involves changing a proxy IP address that is used for the client.

11. The method of claim 1, wherein determining from the at least one communication that access to the web server has been restricted involves determining from the at least one communication that access to the web server has been blocked.

12. The method of claim 1, wherein determining from the at least one communication that access to the web server has been restricted involves determining from the at least one communication that a proxy IP address has been banned by the web server.

13. The method of claim 1, wherein determining from the at least one communication that access to the web server has been restricted involves determining from the at least one communication that the client has been redirected.

14. The method of claim 1, further including receiving training data at a training engine, wherein the training data is obtained from a proxy server that implements a proxy service for the client.

15. A non-transitory computer readable medium comprising instructions to be executed in a computer system, wherein the instructions when executed in the computer system perform a method of operating a proxy server, the method comprising:
determining from at least one communication received at the proxy server that access to a web server has been restricted, wherein the at least one communication is a communication between a client and a web server and the proxy server facilitates a secure tunnel between the client and the web server; and
implementing a remedial action in response to the restricted access determination.

16. A proxy server, the proxy server comprising:
a communications interface;
at least one processor; and
a non-transitory computer readable medium comprising instructions to be executed by the at least one processor, wherein the instructions when executed by the at least one processor perform a method of operating the proxy server, the method comprising:
determining from at least one communication received at the communications interface that access to a web server has been restricted, wherein the at least one communication is a communication between a client and a web server and the proxy server facilitates a secure tunnel between the client and the web server; and
implementing a remedial action in response to the restricted access determination.

17. A method for operating a proxy server, the method comprising:
receiving an encrypted communication at the proxy server, the encrypted communication being part of an encrypted communication between a client and a web server that passes through the proxy server, the client having a client IP address and wherein a portion of the encrypted communication that is between the proxy server and the web server uses a proxy IP address instead of the client IP address;
determining from the encrypted communication that access to the web server has been restricted for the proxy IP address; and
implementing a remedial action in response to the restricted access determination.

18. A method for operating a proxy server, the method comprising:
receiving at least one communication between a client and a web server, wherein the proxy server facilitates a secure tunnel between the client and the web server;
determining from the at least one communication that access to the web server may be restricted; and
implementing a remedial action in response to the restricted access determination.

19. The method of claim 18, wherein determining from the at least one communication that access to the web server may be restricted involves identifying a domain name from the at least one communication and determining that access to the web server has been restricted in response to the identified domain name.

20. The method of claim 18, wherein determining from the at least one communication that access to the web server may be restricted involves identifying a pattern of domain names from multiple communications and determining that access to the web server has been restricted in response to the identified pattern of domain names.
